(19) United States
(12) Patent Application Publication
(10) Pub. No.: US 2006/0012547 A1
(43) Pub. Date: Jan. 19, 2006

(54) Plasma display device and image processing method thereof

(76) Inventor: Geun-Yeong Chang, Suwon-si (KR)

Correspondence Address: CHRISTIE, PARKER & HALE, LLP, PO BOX 7068, PASADENA, CA, 91109-7068, US

(21) Appl. No.: 11/132,095

(22) Filed: May 18, 2005

(30) Foreign Application Priority Data
Jun. 23, 2004 (KR) 10-2004-0047031

(51) Int. Cl. G09G 3/28

(52) U.S. Cl. 345/63

(57) ABSTRACT

A plasma display device and image processing method thereof. A scan method of one-frame video signal data is determined in advance. Data to be compared are selected from among the video signal data according to the determination. It is determined as to whether the one-frame video signal data have high address power consumption by using the data. Address data are re-established when video signal data are found to have high address power consumption.

### CROSS REFERENCE TO RELATED APPLICATION

This application claims priority to and the benefit of Korean Patent Application No. 10-2004-0047031 filed on Jun. 23, 2004 in the Korean Intellectual Property Office, the entire content of which is incorporated herein by reference.

### BACKGROUND OF THE INVENTION

1. Field of the Invention

The present invention relates to a plasma display device and an image processing method thereof.

2. Discussion of the Related Art

Recently, plasma display panels (PDPs) have been highlighted as a type of flat panel display that is advantageous over other flat panel displays with regard to its high luminance, high luminous efficiency, and wide viewing angle.

A plasma display device is a flat panel display that uses plasma generated by gas discharge to display characters or images. It includes a PDP and peripheral circuits. The PDP includes, depending on its size, more than several scores to millions of pixels arranged in a matrix pattern.

Address display separating (ADS) driving is widely used as a method for driving the PDP. The ADS driving method includes a reset period, an address period, and a sustain period. In the reset period, the state of each cell is reset to facilitate an addressing operation on the cell. In the address period, an address voltage is applied to addressed cells to accumulate wall charges thereon so as to select cells that are turned on in the panel and cells that are not turned on in the panel. In the sustain period, a discharge occurs to actually display an image on the addressed cells by applying a sustain pulse.

When subfields are operated according to the above-noted method, capacitance exists on the panel since a discharge space between a scan electrode and a sustain electrode and a discharge space between a surface on which an address electrode is formed and a surface on which a scan electrode and a sustain electrode are formed function as capacitors. Therefore, a large amount of charge-injecting reactive power for generating a predetermined voltage to the capacitor is needed in addition to the power for an address discharge in order to apply an address waveform. Further address power is used when the address electrode is switched many times.

The increased consumption of address power by the increased amount of switching of the address electrode will now be described.

FIG. 1 is a diagram showing image data of a white screen. It can be seen that all pixels in the image data of the white screen have a value of 1. In this case, accordingly, there is little or no data variation of address electrodes. Also, the number of pulse switching operations is small. Thus, reactive power generated during a charging or discharging operation is reduced because power consumption increases in proportion to the number of switching operations. The driving waveform for the image data of the white screen is shown in FIG. 2. As shown in FIG. 1, only one switching operation is required for each column of image data of the white screen, as indicated by a solid line in FIG. 1.

On the other hand, image data may have a dot pattern. FIG. 3 is a diagram showing dot pattern image data. It can be seen that the dot pattern image data has pixel values continuously varying between 1 and 0, so that it requires a number of switching operations. The driving waveform in this case is shown in FIG. 4.

As shown in FIG. 4, in the case of the dot pattern image data, there is a considerable data variation of the address electrodes. Also, pulse switching of the driving waveform is frequently made, thereby causing an increase in power consumption. In addition, in the case of line image data in which an image pattern is varied for each line, the data are varied per line, the number of switching operations is increased, and the address power consumption is increased.

The switching operation is more frequently generated when the number of pixels having different values between the current and previous lines of address data is larger. In this case, an increase in power consumption becomes a problem.

### SUMMARY OF THE INVENTION

In accordance with the present invention a plasma display device is provided for determining a scan method of input image data in advance, comparing data values of corresponding data patterns, and reducing address power consumption.

In one aspect of the present invention, a plasma display device includes an address automatic power control (APC) unit, an address data generator, and an address driver. The address APC unit determines a scan method of video signal data of one frame in advance, selects data to be compared from among the video signal data according to the determination, uses the selected data to determine a level address power consumption of the video signal data of the frame, generates a control signal including a data gain value for re-establishing address data, and transmits the control signal. The address data generator receives the control signal from the address APC unit, generates address data corresponding to the control signal, and transmits an address driving control signal. The address driver applies address data to an address electrode of a pixel to be displayed corresponding to the address driving control signal.

The address APC unit includes a scan determiner and gray scale difference summator, and a gain determiner. The scan determiner and gray scale difference summator determines a scan method of input video signals in advance, and sums per-line gray scale differences on the same column according to the scan method (wherein each line for a summation of the per-line gray scale differences on the same column follows the scan method). The gain determiner determines an address APC level corresponding to the scan determiner and gray scale difference summator, and outputs a data gain value corresponding to the address APC level.

In another aspect of the present invention, an image processing method of a plasma display device is provided for dividing an image of each frame displayed on the plasma display device corresponding to an input video signal into a plurality of subfields, and combining the subfields with brightness weights to display gray scales. In the method, (a) a scan method of video signal data of one frame is determined in advance; (b) data corresponding to the determination in (a) are selected, and the data are used to determine a level of address power consumption of the video signal data of the frame; (c) a control signal including a data gain value for re-establishing address data corresponding to the level determined in (b); (d) address data corresponding to the control signal in (c) is generated, and an address driving control signal is transmitted; and (e) the address data are applied to an address electrode of a pixel to be displayed in correspondence to the address driving control signal in (d).

The level of the address power consumption may be determined in (b) by using a gray scale difference of an adjacent upper line and a lower line on the same column from among the video signal data of one frame when the input video signals follow the progressive scan method in (a). The level of the address power consumption may be determined in (b) by using a gray scale difference between an i^{th} line and an (i+2)^{th} line having another line therebetween on the same column from among the video signal data of one frame when the input video signals follow the interlaced scan method in (a).

The level of the address power consumption may be determined in (b) by using a difference of subfield data of an adjacent upper line and a lower line on the same column from among the video signal data of one frame when the input video signals follow the progressive scan method in (a). The level of the address power consumption may be determined in (b) by using a difference of subfield data between an ith line and an (i+2)^{th} line having another line therebetween on the same column from among the video signal data of one frame when the input video signals follow the interlaced scan method in (a).

### BRIEF DESCRIPTION OF THE DRAWINGS

FIG. 1 shows a diagram for image data of a white screen.

FIG. 2 shows a switching waveform diagram for the image data of FIG. 1.

FIG. 3 shows a diagram showing dot pattern image data.

FIG. 4 shows a switching waveform diagram for the image data of FIG. 3.

FIG. 5 shows an electrode arrangement diagram for a plasma display device according to an exemplary embodiment of the present invention.

FIG. 6 shows a plasma display device according to an exemplary embodiment of the present invention.

FIG. 7 shows a block diagram of a controller of a plasma display device for reducing address power consumption according to an exemplary embodiment of the present invention.

FIG. 8 shows a block diagram of an address APC unit according to a first exemplary embodiment of the present invention.

FIG. 9 shows a graph for gain values with respect to APC levels of FIG. 8.

FIG. 10 shows a diagram for power consumption maximum pattern image data in the interlaced scanning method.

FIG. 11 shows a block diagram of an address APC unit according to a second exemplary embodiment of the present invention.

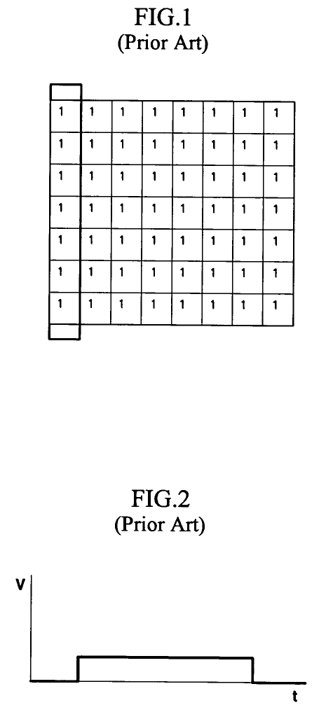

### DETAILED DESCRIPTION

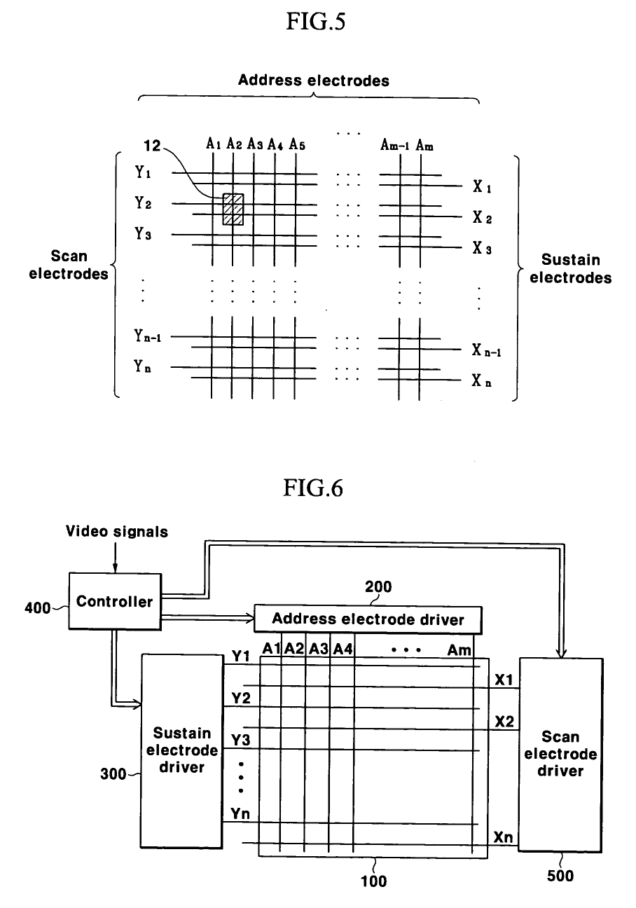

Referring now to FIG. 5, the electrodes of the plasma display device are arranged in the form of an m×n matrix. m address electrodes A1 to Am are arranged in a column direction. n scan electrodes Y1 to Yn and n sustain electrodes X1 to Xn are alternately arranged in a row direction. A discharge space at a node of a pair of a scan electrode and a sustain electrode with an address electrode forms a discharge cell 12.

FIG. 6 shows a plasma display device according to an exemplary embodiment of the present invention. The plasma display device includes a plasma panel 100, an address electrode driver 200, a sustain electrode driver 300, a controller 400, and a scan electrode driver 500.

The plasma panel 100 includes a plurality of address electrodes A1 to Am arranged in the column direction, a plurality of sustain electrodes X1 to Xn arranged in the row direction, and a plurality of scan electrodes Y1 to Yn arranged in the row direction. The address electrode driver 200 receives an address driving control signal from the controller 400 and applies display data signals for selecting desired discharge cells to respective address electrodes A1 to Am. The sustain electrode driver 300 and the scan electrode driver 500 receive control signals from the controller 400 and alternately apply sustain discharge voltages to the sustain electrodes X1 to Xn and the scan electrodes Y1 to Yn to thus sustain-discharge the selected discharge cells.

The controller 400 externally receives red, green, and blue (RGB) video signals and synchronization signals, divides a frame into a plurality of subfields, and divides each subfield into a reset period, an address period, and a sustain period to drive the plasma display device. The controller 400 controls the number of sustain discharge pulses provided to each sustain period of the subfields, and supplies control signals to the address electrode driver 200, the sustain electrode driver 300, and the scan electrode driver 500.

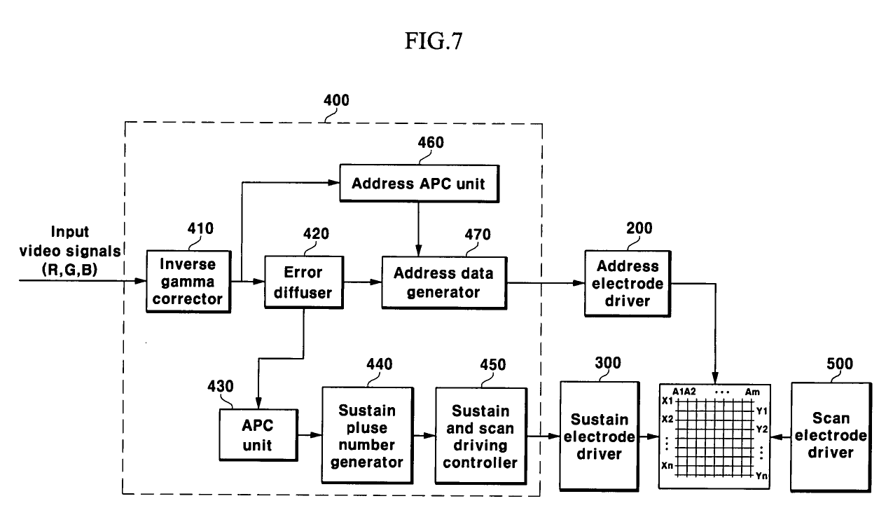

The controller 400 will now be described in more detail with reference to FIGS. 7 to 9.

FIG. 7 shows a block diagram of the controller of a plasma display device for reducing address power consumption according to an exemplary embodiment of the present invention.

The controller 400 includes an inverse gamma corrector 410, an error diffuser 420, an automatic power control (APC) unit 430, a sustain pulse number generator 440, a sustain and scan electrode driving controller 450, an address APC unit 460, and an address data generator 470.

The inverse gamma corrector 410 corrects the n-bit RGB image data into m-bit video signals (m≧n) by mapping the RGB image data on an inverse gamma curve. In the typical plasma display device, n is given as 8, and m is given as 10 or 12.

The video signal input to the inverse gamma corrector 410 is a digital signal, and when an analog video signal is input to the plasma display device, it is necessary to convert the analog signal into a digital signal by using an analog to digital converter (not shown). In addition, the inverse gamma corrector 410 can include a lookup table (not shown) for storing data corresponding to the inverse gamma curve for mapping the video signal, or a logic circuit (not shown) for generating data corresponding to the inverse gamma curve through a logical operation.

The error diffuser 420 error-diffuses the video of low-order m-n bits of m bits, which are inverse gamma-corrected and expanded by the inverse gamma corrector 410, to adjacent pixels and displays the same. Error diffusion is a method for displaying video of low-order bits by separating the video of low-order bits to be error-diffused and diffusing the separated video to adjacent pixels, which is described in detail in Korean Patent Laid-Open Publication No. 2002-0014766.

The APC unit 430 uses video data output by the error diffuser 420 to detect a load ratio, calculates an APC level according to the detected load ratio, generates a number of sustain pulses corresponding to the calculated APC level, and outputs the number thereof.

The sustain pulse number generator 440 uses information on the number of sustain pulses output by the APC unit 330 to allocate a number of sustain pulses of each subfield.

The sustain and scan electrode driving controller 450 generates a control signal corresponding to the number of sustain discharges output by the sustain pulse number generator 440, and outputs the same to the sustain electrode driver 300 and the scan electrode driver 500. It should be noted that the sustain pulse number generator 440 and the sustain and scan electrode driving controller 450 can be realized in a single block.

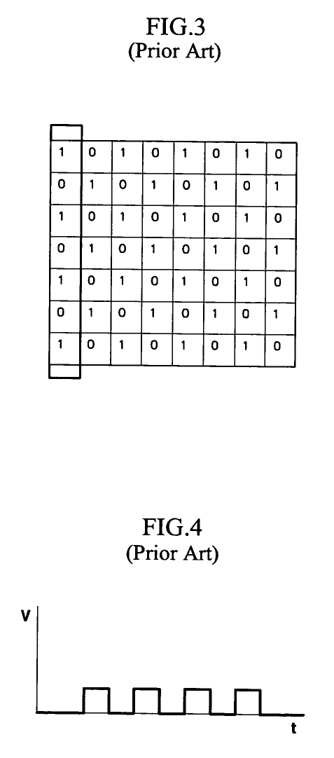

The address APC unit 460 determines whether the data of a frame output by the inverse gamma corrector 410 consumes significant address power, and outputs a data gain to the address data generator 470 for establishing the address data gain to control the power consumption when significant address power is consumed, that is, for example, in the case of a dotted pattern such as shown in FIG. 3.

In the plasma display device the pattern for the maximum address power consumption corresponding to a scan method for a frame may be different and the scan method is predefined. Therefore, the address APC unit 460 determines the scan method of the video signals of a frame input, in advance, selects data to be compared according to the determination, and determines whether the one frame data consume significant address power, and re-establishes address data in order to control the address power consumption when significant address power is consumed.

In this instance, the determination of whether the one frame data consume significant address power is executed by using a gray scale difference (a gray scale difference between a previous pixel and a pixel adjacent in the column direction on the address electrode of the same column, or a gray scale difference between a previous pixel by two lines and a pixel adjacent in the column direction on the address electrode of the same column) or by on/off status of each subfield data (a difference between subfield data of a previous pixel and subfield data of a pixel adjacent in the column direction on the address electrode of the same column, or a difference between subfield data of a previous pixel by two lines and subfield data of a pixel adjacent in the column direction on the address electrode of the same column), which will now be described in more detail.

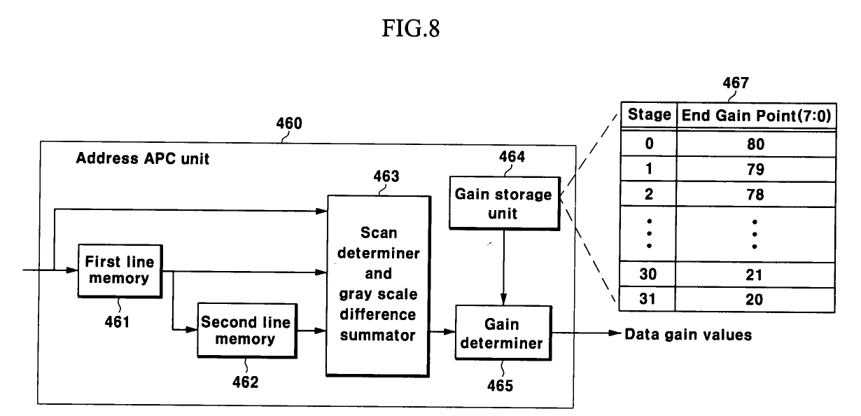

FIG. 8 shows a block diagram of the address APC unit 460 according to a first exemplary embodiment of the present invention. The address APC unit 460 includes a first line memory 461, a second line memory 462, a scan determiner and gray scale difference summator 463, a gain storage unit 464, and a gain determiner 465.

The scan method for the plasma display device includes the progressive scan and the interlaced scan. The progressive scan method is to sequentially scan a screen from top left to the bottom right, and the interlaced scan method is to scan odd lines (or even lines) and then even lines (or odd lines) to thus scan the whole screen. The data pattern consuming significant address power and corresponding to the scan method may be different, and hence, data values to be compared are to be selected differently according to the scan method when one-frame video signals are provided.

An operation of the address APC unit 460 according to the first exemplary embodiment of the present invention will now be described.

The scan determiner and gray scale difference summator 463 determines what scan method the input video signals follows, and selects data to be selected from among the data values of video signals input according to the determination result.

The maximum address power is consumed when the video signals follow the progressive scan method and the data pattern is given to be a dotted pattern as shown in FIG. 3. Therefore, a data value D1 of the current input line and a data value D2 of the one-line-delayed line stored in the first line memory 461 are used, and the same are compared in the column direction to find a gray scale difference and summate the gray scale difference. The sum of gray scale differences of pixels between lines in one frame with N lines and M columns is given in Equation 1.

$$S = {\sum }_{i = 1}^{N} {\sum }_{j = 1}^{M} ( {P}_{i + 1 , j} - {P}_{i , j} ) \qquad Equation 1$$

where P is a gray scale value of a pixel, i is a line, and j is a column. Equation 1 can be varied in many ways, such as to perform a per-line operation and find a total sum.

The scan determiner and gray scale difference summator 463 summates gray scale differences between lines pursuant to Equation 1, and outputs the sum to the gain determiner 465.

The gain determiner 465 determines an APC level corresponding to the sum S of gray scale differences, refers to a lookup table 467 of the gain storage unit 464 to determine an end gain corresponding to the APC level, and outputs the end gain. The gain values corresponding to the APC level are exemplarily given in FIG. 9 and the same can be varied, which would be apparent to a person skilled in the art.

The gain values are inversely proportional to the sum of gray scale differences and are given as between 0 and 1. A large sum thereof represents that a data (gray scale) difference between pixels is large. The large sum thereof increases power consumption and it is required to reduce the data difference between pixels by multiplying the gain value.

The gain value is given as 1 when the sum is 0, and the same is reduced as the sum increases. The gain value can be established from experiments, and can be stored in a lookup table format. In addition, the gain value can be varied within a range in which the original video signals are not modified, and the same can be designed to be greater than 1.

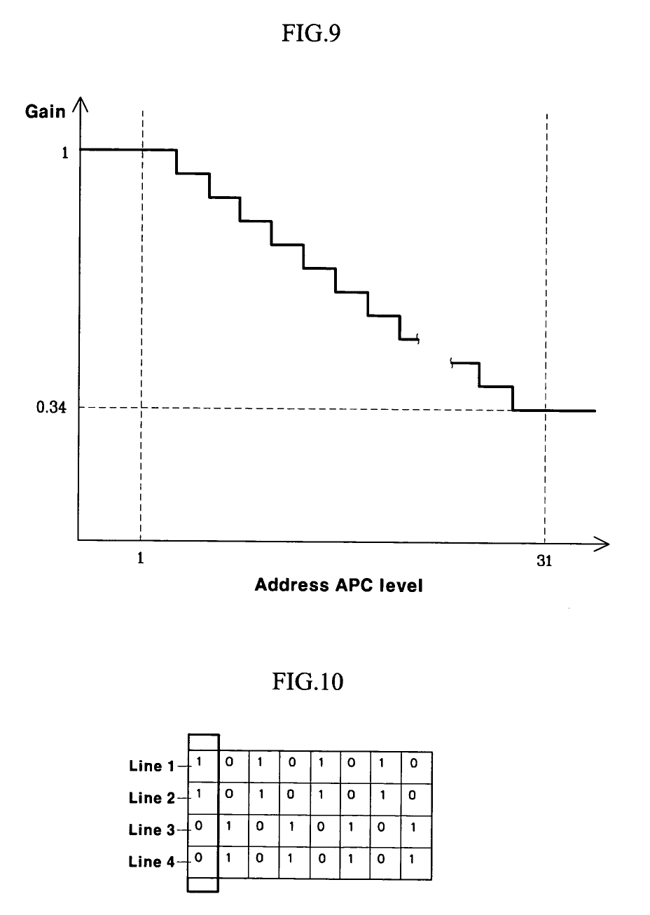

When the input video signals follow the interlaced scan method and the input data pattern is a pattern as shown in FIG. 10, the maximum address power is consumed. Therefore, a data value D1 of the current input line and a data value D3 of the two-line-delayed line stored in the second line memory 462 are used since the gray scale difference between a current line and another line which is previous by two lines, and the data values D1 and D3 are compared in the column direction to find a gray scale difference and summate the gray scale difference. The sum of gray scale differences of the current input lines (Line 3 of FIG. 10) and lines before two lines (Line 1 of FIG. 10) in one frame with N lines and M columns is given in Equation 2.

$$S = {\sum }_{i = 1}^{N} {\sum }_{j = 1}^{M} ( {P}_{i + 2 , j} - {P}_{i , j} ) \qquad Equation 2$$

where P is a gray scale value of a pixel, i is a line, and j is a column. Equation 2 can be varied in many ways, such as to perform a per-line operation and find a total sum.

The scan determiner and gray scale difference summator 463 summates gray scale differences between lines pursuant to Equation 2, and outputs the sum to the gain determiner 465.

In general, the address APC unit 460 determines address power consumption status of data according to the gray scale difference for each line in the first embodiment since a large gray scale difference per line increases power consumption, which is incorrect since the address power consumption relates to address data, that is, subfield data. A method for determining largeness or smallness of the address power consumption through subfield data will now be described.

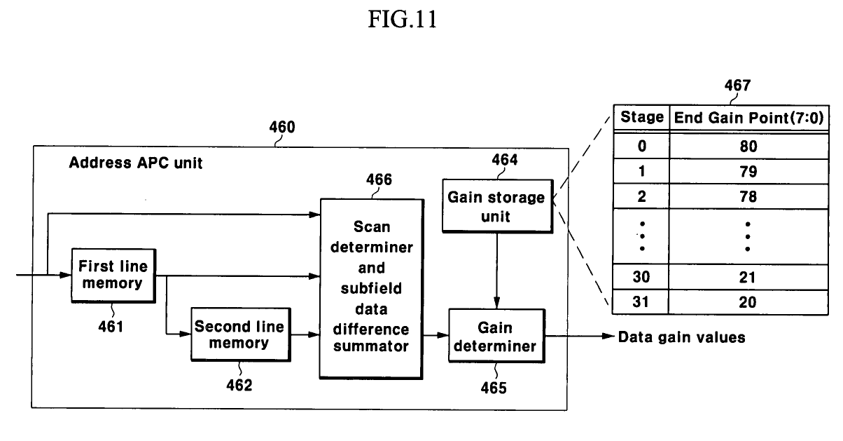

FIG. 11 shows a block diagram of the address APC unit 460′ according to a second exemplary embodiment of the present invention. The address APC unit 460 includes a first line memory 461, a second line memory 462, a scan determiner and subfield data difference summator 466, a gain storage unit 464, and a gain determiner 465. In this instance, no description of the repeated components will be provided except for the scan determiner and subfield data difference summator 466.

The scan determiner and subfield data difference summator 466 uses per-subfield on/off data converted from video signals, that is, subfield data, to summate differences of subfield data between upper lines and lower lines adjacent in the column direction (that is, row lines). It is desirable in this instance to provide a data processor (not shown) before or as part of the scan determiner and subfield data difference summator 466. That is, the data processor converts the input video signals into per-subfield on/off data. When it is assumed that a frame is divided into eight subfields 1SF to 8SF having sustain periods with weights of 1, 2, 4, 8, 16, 32, 64, and 128 and the subfields are then driven, the data processor exemplarily converts a video signal with the gray scale of 100 into 8-bit data of “00100110.” The digits ‘0’ and ‘1’ sequentially correspond to the eight subfields 1SF to 8SF: ‘0’ represents that a discharge cell (a dot) is not discharged (is turned off) in the corresponding subfield, and ‘1’ indicates that a discharge cell is discharged (is turned on) in the corresponding subfield.

Also, the scan determiner and subfield data difference summator 466 selects differently data to be compared according to the scan method of the input video signals.

When the input video signals follow the progressive scan method, the scan determiner and subfield data difference summator 466 summates differences of subfield data values of the adjacent upper and lower lines from the video signals converted into per-subfield on/off data by the data processor, and summates the differences of the total subfields in one frame. Since the variation of switching which consumes significant address power is generated when a discharge cell is turned on and another discharge cell is turned off from among two discharge cells adjacent in the column direction (i.e., the vertical direction in FIG. 3), the scan determiner and subfield data difference summator 466 can calculate the total of differences of on/off data of the two discharge cells with the subfields as given in Equation 3.

$$AP = {\sum }_{i = 1}^{n - 1} {\sum }_{j = 1}^{m} ( \vert {R}_{ij} - {R}_{( i + 1 ) j} \vert + \vert {G}_{ij} + {G}_{( i + 1 ) j} \vert + \vert {B}_{ij} + {B}_{( i + 1 ) j} \vert ) \qquad Equation 3$$

where Rᵢⱼ, Gᵢⱼ, and Bᵢⱼ are on/off data of RGB discharge cells of the i^{th} row and j^{th} column. The scan determiner and subfield data difference summator 466 uses Equation 3 to find values of the each subfield, and summates the values for the total subfields in one frame. Largeness, smallness, existence, and non-existence of the address power consumption are determined by the summation of subfield data differences of each subfield, and the same can also be determined by summing the values for the total subfields as given in Equation 3.

When the input video signals follow the interlaced scan method, the scan determiner and subfield data difference summator 466 summates differences of subfield data values of a current line and another line prior to the current line by two lines from the video signals converted into per-subfield on/off data by the data processor, and summates the differences of each subfield for the total subfields in one frame. Since the variation of switching which consumes significant address power is generated when a discharge cell is turned on and another discharge cell is turned off from among a discharge cell and another discharge cell prior to the discharge cell by two discharge cells in the column direction (i.e., the vertical direction in FIG. 10), the scan determiner and subfield data difference summator 466 can calculate the total of differences of on/off data of the two adjacent discharge cells with respect to a discharge cell provided therebetween, as given in Equation 4.

$$AP = {\sum }_{i = 1}^{n - 1} {\sum }_{j = 1}^{m} ( \vert {R}_{ij} - {R}_{( i + 2 ) j} \vert + \vert {G}_{ij} + {G}_{( i + 2 ) j} \vert + \vert {B}_{ij} + {B}_{( i + 2 ) j} \vert ) \qquad Equation 4$$

where Rᵢⱼ, Gᵢⱼ, and Bᵢⱼ are on/off data of RGB discharge cells of the i^{th} row and j^{th} column. The scan determiner and subfield data difference summator 466 uses Equation 4 to find values of each subfield, and summates the values for the total subfields in one frame. Largeness, smallness, existence, and non-existence of the address power consumption are determined by the summation of subfield data differences of each subfield, and the same can also be determined by summing the values for the total subfields as given in Equation 4.

In general, the address APC unit 460′ includes a first line memory 461 and a second line memory 462 as shown in FIG. 11 so as to evaluate the difference of on/off data of two adjacent discharge cells or the difference of on/off data of two discharge cells with a discharge cell provided therebetween, and to store video signals of one row since the video signals are sequentially input in the row order. The first line memory 461 and the second line memory 462 sequentially store per-subfield on/off data for video signals of one row (one line), and the scan determiner and subfield data difference summator 466 reads data of a previous line stored in the first line memory in correspondence to the scan method of the input video signals to calculate the difference of on/off data in the adjacent two discharge cells for each subfield, or reads data of a line prior to two lines stored in the second line memory 462 to calculate the difference of on/off data in the adjacent two discharge cells with a discharge cell provided therebetween for each subfield. Also, the scan determiner and subfield data difference summator 466 can use an XOR (exclusive OR) operation to calculate the difference of on/off data in the two discharge cells selected corresponding to the scan method.

The gain determiner 465 determines an APC level corresponding to the summation of differences of on/off data of the total subfields (or each subfield) of one frame, determines an end gain corresponding to the APC level by referring to the lookup table 467 of the gain storage unit 464, and outputs the end gain in the case of the progressive scan method, or the gain determiner 465 determines an APC level corresponding to the summation of differences of on/off data between the current line and the line prior to the current line by two lines in the total subfields (or each subfield) of one frame, determines an end gain corresponding to the APC level by referring to the lookup table of the gain storage unit 464, and outputs the end gain in the case of the interlaced scan method, according to the result of the scan determiner and subfield data difference summator 466 corresponding to the scan method of the input video signals.

Referring back to FIG. 7, when using the address APC unit 460′ in place of address APC unit 460, the address data generator 470 would multiply the video signals by the data gain value output from the address APC unit 460′ to output correction data, generate subfield data corresponding to the correction data, rearrange the subfield data to be address data for driving the plasma display device to generate address control signals for controlling the address electrode driver 200, and output the address control signals to the address electrode driver 200.

In this instance, the APC unit 460′ would include a data processor (not shown) for converting input video signals to subfield data, and is allowed to use the subfield data generated by the address data generator 470 and find the summation of differences of subfield data as shown in Equations 3 and 4.

The address APC units 460, 460′ according to the first and second exemplary embodiments of the present invention are separately provided from the address data generator 470, and it would be apparent to a person skilled in the art that the respective address APC units 460, 460′ and the address data generator 470 can be realized as a single body.

The address APC units 460, 460′ determine largeness, smallness, existence, and non-existence status of power consumption by using the data output by the inverse gamma corrector 410, and can also determine the same by using the signals output by the error diffuser 420.

According to the present invention, largeness, smallness, existence, and non-existence status of address power consumption are determined by selecting different data according to the scan method of input video signals and using per-line gray scale differences of corresponding data or differences of data values of per-line subfield data.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display device comprising:
an address automatic power control unit adapted to determine a scan method of video signal data of one frame in advance, to select data to be compared from among the video signal data according to the determination, to use the selected data to determine a level of address power consumption of the video signal data of the frame, to generate a control signal including a data gain value for re-establishing address data, and to transmit the control signal;
an address data generator adapted to receive the control signal from the address automatic power control unit, to generate address data corresponding to the control signal, and to transmit an address driving control signal; and
an address driver adapted to apply address data to an address electrode of a pixel to be displayed corresponding to the address driving control signal.

2. The plasma display device of claim 1, wherein the address automatic power control unit comprises:
a scan determiner and gray scale difference summator adapted to determine a scan method of input video signals in advance, and to sum per-line gray scale differences on the same column according to the scan method, each line for a summation of the per-line gray scale differences on the same column following the scan method; and
a gain determiner adapted to determine an address automatic power control level corresponding to the scan determiner and gray scale difference summator, and to output a data gain value corresponding to the address automatic power control level.

3. The plasma display device of claim 2, wherein the address automatic power control unit determines a level of the address power consumption by using a gray scale difference of an adjacent upper line and a lower line on the same column from among the video signal data of one frame.

4. The plasma display device of claim 2, wherein the address automatic power control unit determines whether the address power consumption is high by using a gray scale difference between an i^{th} line and an (i+2)^{th} line having another line therebetween on the same column from among the video signal data of one frame.

5. The plasma display device of claim 1, wherein the address automatic power control unit comprises:
a scan determiner and subfield data difference summator adapted to determine a scan method of input video signals in advance, and to sum per-line subfield data differences on the same column according to the scan method, each line for a summation of the per-line subfield data differences on the same column following the scan method; and
a gain determiner adapted to determine an address automatic power control level corresponding to the scan determiner and subfield data difference summator, and to output a data gain value corresponding to the address automatic power control level.

6. The plasma display device of claim 5, wherein the address automatic power control unit determines whether the address power consumption is high by using subfield data of an adjacent upper line and a lower line on the same column from among the video signal data of one frame.

7. The plasma display device of claim 5, wherein the address automatic power control unit determines whether the address power consumption is high by using subfield data between an i^{th} line and an (i+2)^{th} line having another line therebetween on the same column from among the video signal data of one frame.

8. An image processing method of a plasma display device for dividing an image of each frame displayed on the plasma display device corresponding to an input video signal into a plurality of subfields and combining the subfields with brightness weights to display gray scales, the method comprising:
(a) determining a scan method of video signal data of one frame in advance;
(b) selecting data corresponding to a determination in (a), and using the data to determine a level of address power consumption of the video signal data of the frame;
(c) generating a control signal including a data gain value for re-establishing address data corresponding to a level determined in (b);
(d) generating address data corresponding to a control signal generated in (c), and transmitting an address driving control signal; and
(e) applying the address data to an address electrode of a pixel to be displayed in correspondence to an address driving control signal transmitted in (d).

9. The image processing method of claim 8,
wherein (b) comprises determining a level of the address power consumption by using a gray scale difference of an adjacent upper line and a lower line on the same column from among the video signal data of one frame when the input video signals follow the progressive scan method in (a), and
wherein (b) further comprises determining the level of the address power consumption by using a gray scale difference between an i^{th} line and an (i+2)^{th} line having another line therebetween on the same column from among the video signal data of one frame when the input video signals follow the interlaced scan method in (a).

10. The image processing method of claim 8,
wherein (b) comprises determining the level of the address power consumption by using a difference of subfield data of an adjacent upper line and a lower line on the same column from among the video signal data of one frame when the input video signals follow the progressive scan method in (a), and
wherein (b) further comprises determining the level of the address power consumption by using a difference of subfield data between an i^{th} line and an (i+2)^{th} line having another line therebetween on the same column from among the video signal data of one frame when the input video signals follow the interlaced scan method in (a).
